(19) United States
(12) Patent Application Publication
(10) Pub. No.: US 2026/0189353 A1
(43) Pub. Date: Jul. 2, 2026

(54) TERMINAL APPARATUS, BASE STATION APPARATUS, CONTROL METHOD, AND COMPUTER-READABLE STORAGE MEDIUM FOR USING SPECIFIC FREQUENCY BAND IN SUPPLEMENTARY MANNER FOR UPLINK COMMUNICATION

(71) Applicant: KDDI CORPORATION, Tokyo (JP)

(72) Inventors: Mikihiro ARUGA, Tokyo (JP); Masahito UMEHARA, Tokyo (JP); Masaya SHIBAYAMA, Tokyo (JP); Toshikazu YOUKAI, Tokyo (JP)

(21) Appl. No.: 19/549,123

(22) Filed: Feb. 25, 2026

Related U.S. Application Data
(63) Continuation of application No. PCT/JP2024/031854, filed on Sep. 5, 2024.

(30) Foreign Application Priority Data
Sep. 19, 2023 (JP) 2023-150822

(51) Int. Cl. H04L 5/00; H04W 52/32

(52) U.S. Cl. CPC H04L 5/0098; H04L 5/0044; H04W 52/325

(57) ABSTRACT

A terminal apparatus establishes a connection with a first base station apparatus in a first frequency band, and establishes a connection with a base station apparatus different from the first base station apparatus in a second frequency band, transmits a predetermined signal in the second frequency band, receives, from the first base station apparatus, information that is based on a reception quality of the predetermined signal at a second base station apparatus and that enables identifying a transmission power to be used to transmit a signal to the second base station apparatus, the second base station apparatus operating in the second frequency band and not being regarded as being located at the same position as the first base station apparatus, and identifies the transmission power based on the information.

### CROSS-REFERENCE TO RELATED APPLICATION(S)

This application is a continuation of International Patent Application No. PCT/JP2024/031854 filed on Sep. 5, 2024, which claims priority to and the benefit of Japanese Patent Application No. 2023-150822 filed on Sep. 19, 2023, the entire disclosures of which are incorporated herein by reference.

### BACKGROUND OF THE INVENTION

### Field of the Invention

The present disclosure relates to a control technique for using a specific frequency band in a supplementary manner for uplink communication.

### Description of the Related Art

From the perspective of the effective use of radio waves, it is effective for frequency band allocated to one specific purpose of use to be further allocated also to another purpose of use. For example, the 2.3 GHz band, which is used by radio stations for public services and radio relay transmission devices used by broadcasters, has also been newly allocated to cellular communication. In such a frequency band, systems to which the frequency band has been newly allocated need to be operated so as not to interfere with the operation of incumbent users. For example, in the above-described 2.3 GHz band, the interference caused by cellular communication system signals to devices of incumbent users (radio stations for public services and radio relay transmission devices used by broadcasters) must be kept below a predetermined level.

Here, if a base station apparatus belonging to a cellular communication system transmits a downlink signal, the signal may propagate over a wide area due to the transmission power of signals from base station apparatuses being high, etc. On the other hand, if a terminal apparatus belonging to the cellular communication system transmits an uplink signal, the signal would propagate only over a limited area due to the relatively low transmission power thereof. The circumstances being such, it is conceivable to configure the cellular communication system so that only uplink signals are transmitted therein in order to effectively use the frequency band while suppressing interference to radio stations for public services and radio relay transmission devices used by broadcasters. For example, it is conceivable to configure the cellular communication system such that, while a frequency band allocated exclusively to cellular communication is allocated to uplink and downlink communications, a frequency band shared with other systems is used in a supplementary manner to strengthen uplink communication.

### SUMMARY OF THE INVENTION

The present disclosure provides a control technique for enabling communication to be carried out in an effective manner in an environment in which a specific frequency band is used in a supplementary manner for uplink communication.

According to one aspect of the present invention, there is provided a terminal apparatus comprising: one or more processors; and one or more memories that store a computer-readable instruction for causing, when executed by the one or more processors, the one or more processors to execute a control method including: establishing a connection with a first base station apparatus in a first frequency band, and establishing a connection with a base station apparatus that is different from the first base station apparatus in a second frequency band that is different from the first frequency band; transmitting a predetermined signal in the second frequency band; receiving, from the first base station apparatus, information that is based on a reception quality of the predetermined signal at a second base station apparatus and that enables identifying a transmission power to be used to transmit a signal to the second base station apparatus, the second base station apparatus operating in the second frequency band and not being regarded as being located at the same position as the first base station apparatus; and identifying the transmission power based on the information, and transmitting a signal to the second base station apparatus in the second frequency band using the transmission power.

According to one aspect of the present invention, there is provided a base station apparatus that operates in a first frequency band, comprising: one or more processors; and one or more memories that store a computer-readable instruction for causing, when executed by the one or more processors, the one or more processors to execute a control method including: acquiring information about a reception quality when a predetermined signal transmitted from a terminal apparatus in a second frequency band that is different from the first frequency band is received by a first other base station apparatus that operates in the second frequency band and that is not regarded as being located at a same position as the base station apparatus; and based on the reception quality, generating information that enables identifying a transmission power to be used by the terminal apparatus to transmit a signal to the first other base station apparatus, and transmitting the information to the terminal apparatus in the first frequency band.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram illustrating an example of a configuration of a radio communication system;

FIG. 2 is a diagram for describing frequency bands used by base station apparatuses;

FIG. 3 is a diagram illustrating an example of a processing procedure during initial connection;

FIG. 4 is a diagram illustrating an example of a processing procedure during transmission of uplink data;

FIG. 5 is a diagram illustrating an example of a processing procedure for switching a connection-destination SUL base station;

FIG. 6 is a diagram illustrating an example of a hardware configuration of apparatuses;

FIG. 7 is a diagram illustrating an example of a functional configuration of a terminal apparatus; and

FIG. 8 is a diagram illustrating an example of a functional configuration of a base station apparatus (NUL base station).

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

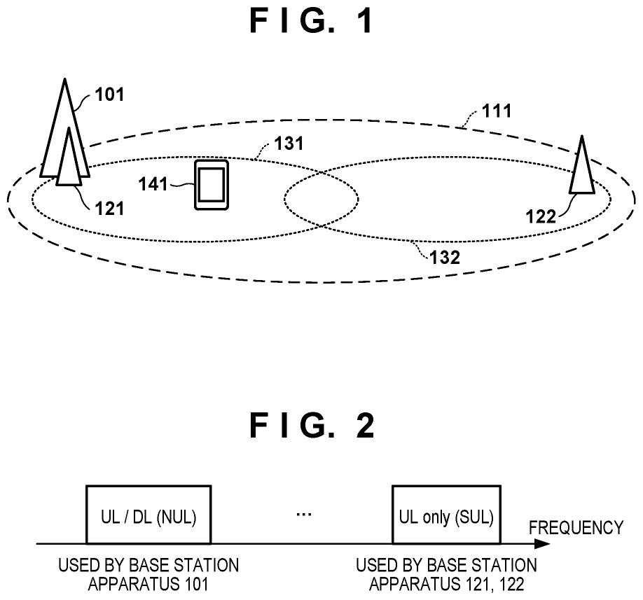

FIG. 1 illustrates an example of a configuration of a radio communication system according to the present embodiment. The present radio communication system is a cellular communication system conforming to a standard such as the Fifth Generation (5G) of the Third Generation Partnership Project (3GPP) for example, and includes, for example, a base station apparatus 101, a base station apparatus 121, a base station apparatus 122, and terminal apparatus 141. Note that, while only a small number of base station apparatuses and a terminal apparatus are illustrated in order to simplify the explanation, more base station apparatuses and terminal apparatuses may be included, as a matter of course. For example, the base station apparatus 101 is a base station apparatus that operates in a first frequency band, and provides a radio communication service to terminal apparatuses present within a cell 111 using radio resources in the first frequency band. For example, the base station apparatus 121 and the base station apparatus 122 are base station apparatuses that operate in a second frequency band, and respectively provide a cell 131 and a cell 132 for example. Furthermore, the base station apparatus 101 and the base station apparatus 121 are in a relationship such that the base station apparatus 101 and the base station apparatus 121 are regarded as being located at the same position as one another. Specifically, the base station apparatus 101 and the base station apparatus 121 may actually be disposed at different positions; however, the base station apparatus 101 and the base station apparatus 121 are in a relationship such that these base station apparatuses are regarded as being connected to a given terminal apparatus via transmission paths that are substantially the same (on condition that the same frequency band is used, for example). Furthermore, the relationship between the base station apparatus 122 and the base station apparatus 101 is such that the base station apparatus 122 is not regarded as being located in the same position as the base station apparatus 101. Specifically, the base station apparatus 101 and the base station apparatus 122 are in a relationship such that these base station apparatuses are at least connected to a terminal apparatus via different transmission paths, one example of which being a case in which the two base station apparatuses are located at positions at a significant distance from one another.

Here, as illustrated in FIG. 2, the first frequency band used by the base station apparatus 101 is a frequency band in which both uplink (UL) and downlink (DL) signals are transmitted, and the second frequency band used by the base station apparatus 121 and the base station apparatus 122 is a frequency band in which only uplink signals are transmitted. Specifically, the base station apparatus 121 and the base station apparatus 122 may be configured so as to be capable of receiving signals from terminal apparatuses but incapable of transmitting signals to terminal apparatuses. The terminal apparatus 141 mainly establishes connection with the base station apparatus 101 to perform the transmission of uplink signals and the reception of downlink signals in the first frequency band, and, when necessary, establishes connection with the base station apparatus 121 or the base station apparatus 122 to transmit uplink signals in the second frequency band. That is, the second frequency band is used in a supplementary manner. In the following, uplink communication performed using this supplementary frequency band is referred to as Supplementary UL (SUL). Furthermore, a cell provided in the second frequency band for SUL may be referred to as an SUL cell, and a base station apparatus that provides the SUL cell may be referred to as an SUL base station. On the other hand, uplink communication in a frequency band in which downlink communication can also be performed may be referred to as Normal UL (NUL), a cell that is provided in the first frequency band for NUL may be referred to as an NUL cell, and a base station apparatus that provides the NUL cell may be referred to as an NUL base station. Furthermore, in the present embodiment, the second frequency band is a higher frequency band than the first frequency band. Thus, for example, the propagation loss of signals in the second frequency band is greater than that of signals in the first frequency band, and an SUL cell (cell 131 and cell 132) may be configured to cover a smaller area than an NUL cell (cell 111).

In an environment as described above in which SUL cells are used, the procedure when the terminal apparatus 141 performs communication via an SUL cell requires special consideration. That is, in an SUL cell, the terminal apparatus 141 transmits uplink signals but downlink signals are not transmitted. Due to this, the terminal apparatus 141 cannot perform path loss estimation, etc., based on signals transmitted from an SUL base station, and thus it is not necessarily easy to appropriately set the transmission power of uplink signals. Furthermore, because the terminal apparatus 141 does not measure signals transmitted from SUL base stations, the determination of the SUL base station to which the terminal apparatus 141 is to be connected cannot be performed based on measurement by the terminal apparatus 141. Thus, it is conceivable that conventional processing cannot be directly applied for processing during initial connection, handover, etc.

In view of such circumstances, in the present embodiment, a technique is provided that makes it possible for the terminal apparatus 141 to appropriately execute SUL communication. Note that, in the following, it is described that network-side control is executed by the base station apparatus 101 unless explicitly stated otherwise; however, such control may be executed by another apparatus such as a server on a network, instead of the base station apparatus 101. For example, the above-described base station apparatus 101 and another base station apparatus (for example, the base station apparatus 121 and the base station apparatus 122) that provides an SUL cell that has a geographical area overlapping the NUL cell provided by the base station apparatus 101 may be implemented by means of remote radio heads (RRHs) that are housed in the same baseband unit (BBU), in which case the following control may be executed by the BBU or another apparatus that is connected to the BBU. Note that, in this case, the transmission and reception of messages between the NUL and SUL base stations via an inter-base-station interface need not be performed. For example, in a case in which the NUL and SUL base stations are both housed in the same BBU, messages do not need to be exchanged between these base stations because all information relating to the NUL and SUL base stations is aggregated in the BBU. Furthermore, in a case in which there is another apparatus that collects information relating to the SUL base station to execute various types of control for example, the transmission and reception of information between the base stations need not be performed because it is sufficient that the SUL base station provide information to the apparatus and the apparatus provide control information generated based on the collected information to the NUL base station.

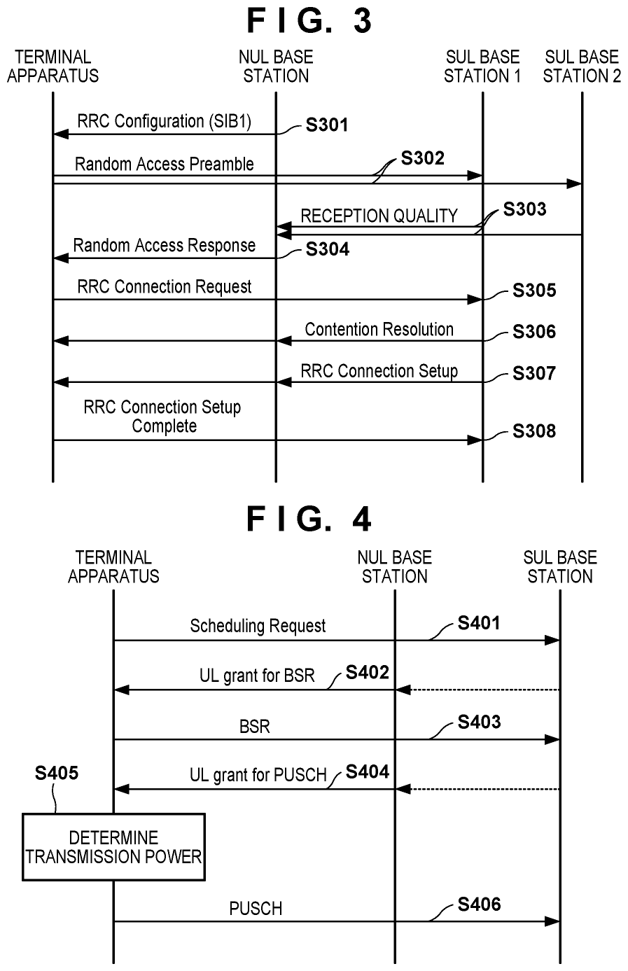

In the present embodiment, for example, radio resources (frequency and time resources) in the second frequency band for transmitting the same random access preamble to one or more SUL cells that each provide a communication service in a geographical area shared with the NUL cell provided by the base station apparatus 101 (i.e., one or more SUL cells that at least partially overlap the NUL cell) are prepared. Note that here, the SUL cells that at least partially overlap the NUL cell are, in other words, SUL cells that may be used in combination with the NUL cell, and a configuration may be adopted such that SUL cells that are not used in combination with the NUL cell are not included. Furthermore, in a case in which a terminal apparatus (for example, the terminal apparatus 141) connected to the base station apparatus 101 needs to establish connection with an SUL cell, the terminal apparatus transmits the random access preamble using the radio resources. The base station apparatus 101 may collect and compare the received qualities (for example, signal-to-interference-plus-noise ratios (SINRs)) of the random access preamble at the base station apparatus 121 and the base station apparatus 122 (SUL base stations), and ensure that the terminal apparatus is connected to the SUL base station having better a reception quality. An example flow of this processing is illustrated in FIG. 3.

For example, if it is determined by an NUL base station (for example, the base station apparatus 101) that a terminal apparatus is to use SUL, a message including an instruction to connect to an SUL cell is transmitted to the terminal apparatus from the NUL base station (step S301). For example, the base station apparatus 101 may determine to cause the terminal apparatus 141 to use SUL if the reception quality (for example, the reference signal received power (RSRP) or the reference signal received quality (RSRQ) of an uplink reference signal (for example, a sounding reference signal (SRS)) from the terminal apparatus 141 falls below a predetermined value or exceeds a different predetermined value. Note that the measurement target may be a physical uplink control channel (PUCCH), etc., and any signal for which the measurement can be executed may be used as the predetermined signal that is measured. Note that the message including the instruction to connect to an SUL base station may be a radio resource control (RRC) layer message such as an RRC Configuration message, for example. Here, the resources (frequency and time resources) for transmitting the random access preamble and configuration information of a sequence to be used to generate the preamble may be reported via this message. Furthermore, for example, the configuration information may be system information block type 1 (SIB1). Furthermore, as described later, the configuration information may include information relating to the transmission power to be used to transmit the random access preamble.

Upon receiving the message including the instruction to connect to an SUL base station, the terminal apparatus transmits the random access preamble (random-access-procedure message 1) using the sequence and the resources in the second frequency band for SUL cells (step S302). Note that the sequence and the resources are set so as to be the same for SUL cells that can be used in combination with the NUL cell that the terminal apparatus is currently connected to, and, for example, a plurality of SUL base stations (e.g., base station apparatus 121 and base station apparatus 122) can each receive the random access preamble. The SUL base stations each report, to the NUL base station, the reception quality (for example, the SINR) when the random access preamble was received (step S303). For example, this report may include information to be transmitted to the terminal apparatus in a random access response. Based on the reported received qualities, the NUL base station determines the SUL base station that the terminal apparatus should establish connection with. Furthermore, because the SUL base stations cannot transmit random access responses, the NUL base station transmits, to the terminal apparatus, a random access response (random-access-procedure message 2) in the first frequency band on behalf of the SUL base station that the terminal apparatus should establish connection with (step S304). Note that, here, the NUL base station may transmit, to each SUL base station, a report including information indicating whether or not the SUL base station has been selected as the connection destination of the terminal apparatus. Subsequently, in accordance with the random access response, the terminal apparatus transmits an RRC Connection Request message (random-access-procedure message 3) using the designated resources in the second frequency band (step S305). Upon receiving the message, the SUL base station determined as the connection destination of the terminal apparatus transmits a Contention Resolution (random-access-procedure message 4) to the NUL base station, and the NUL base station transmits the Contention Resolution to the terminal apparatus in the first frequency band (step S306). Furthermore, an RRC Connection Setup message is transmitted from the SUL base station to the NUL base station, and the message is provided to the terminal apparatus from the NUL base station using the first frequency band (step S307). Upon receiving the message, the terminal apparatus transmits an RRC Connection Setup Complete message to the SUL base station using the second frequency band. Thus, connection between the terminal apparatus and the SUL base station is established. After establishing the connection with the SUL base station, the terminal apparatus can transmit a scheduling request and transmit uplink data.

Here, in general, a terminal apparatus determines, as the transmission power for transmitting a random access preamble, power obtained by adding a path loss value to the target received power of the random access preamble at a base station apparatus (the maximum transmission power if the value exceeds the maximum transmission power of the terminal apparatus). This path loss is determined based on the received power of a downlink signal transmitted from the base station apparatus. However, because the SUL base stations according to the present embodiment do not transmit downlink signals, a terminal apparatus cannot estimate the path loss between the SUL base stations and itself.

In view of such circumstances, the terminal apparatus according to the present embodiment adopts, as the transmission power value for transmitting the random access preamble to the SUL base stations, the transmission power if the random access preamble were to be transmitted to the NUL base station. Specifically, because the terminal apparatus can receive a downlink signal from the NUL base station, the terminal apparatus identifies the path loss between the NUL base station and itself based on the signal, and, based on the path loss, determines the initial transmission power of the random access preamble transmitted in step S302.

Here, there may be a significant difference between required transmission power values due to the difference in frequency between the first and second frequency bands. For example, when the second frequency band is a higher frequency band than the first frequency band, the path loss in the second frequency band would be higher than that in the first frequency band. Due to this, for example, if the random access preamble is transmitted at a transmission power determined based on path loss in the first frequency band, the SUL base stations may not be capable of detecting the random access preamble. If the random access preamble is not detected, no random access response is transmitted, and the terminal apparatus ends up retransmitting the random access preamble. When retransmitting the random access preamble, the terminal apparatus increases the transmission power of the random access preamble by a predetermined amount. Here, if there is a significant difference in path loss due to the difference in frequency between the first and second frequency bands, it may take a long time for the transmission power of the random access preamble to reach the appropriate power. Due to this, in the present embodiment, a configuration is adopted such that power increase information for designating the amount of increase in power is transmitted from the network side (i.e., from the NUL base station) to the terminal apparatus. For example, the NUL base station reports, to the terminal apparatus via an RRC Reconfiguration message, SIB1, or the like in step S301, power increase information indicating the amount of increase in transmission power when the random access preamble is retransmitted in the second frequency band. For example, the amount of increase in transmission power indicated by the power increase information is determined based on the difference between the magnitudes of the free-space propagation loss in the first and second frequency bands. For example, the difference between the magnitudes of the free-space propagation loss itself may be directly designated as the amount of increase in transmission power, or a value obtained by multiplying the difference by a predetermined coefficient (for example, less than 1) may be designated as the amount of increase in transmission power. Note that the amount of increase in transmission power may be determined without using the free-space propagation loss as the basis. For example, amounts of increase in transmission power corresponding to frequency differences or combinations of frequency bands that are used may be experimentally or empirically identified and managed in the form of a table. In this case, the amount of increase in transmission power corresponding to the relationship between the first and second frequency bands may be acquired by referring to the table for management.

The terminal apparatus receives the power increase information in step S301. Then, for example, if no random access response is received for the random access preamble transmitted in step S302 using a transmission power identified based on the path loss between the NUL base station and itself, the terminal apparatus determines, as the transmission power for retransmitting the random access preamble, power obtained by adding the amount of increase indicated by the power increase information to the initial transmission power. Then, the terminal apparatus retransmits the random access preamble using the determined transmission power. Note that, if no random access response is received even when the retransmission is performed, the terminal apparatus once again determines a value obtained by adding the amount of increase indicated by the power increase information to the previous transmission power as the next transmission power, and retransmits the random access preamble using the determined power. Note that, if the power obtained by adding the amount of increase indicated by the power increase information exceeds the maximum transmission power thereof, the terminal apparatus may retransmit the random access preamble using the maximum transmission power. Note that, as the transmission power for the initial transmission of the random access preamble, the terminal apparatus may use a power obtained by adding the amount of increase indicated by the power increase information to the transmission power specified based on the path loss between the NUL base station and itself.

Note that the terminal apparatus can hold the power increase amount increased during the period from when the random access preamble is initially transmitted to when the random access preamble is detected by one or more SUL base stations, and use the power increase amount for the subsequent transmission of the scheduling request and data. Specifically, for example, the terminal apparatus may identify a path loss based on a downlink signal from the NUL base station, and use, as the transmission power for transmitting an uplink signal to an SUL base station, a power obtained by adding the held power increase amount value to the transmission power identified according to the conventional procedure based on the identified path loss.

Note that, even if the terminal apparatus uses such transmission power, accurate reception of an uplink signal by the SUL base station may become impossible due to the effect of multipath, etc., in the second frequency band. In this regard, for example, the terminal apparatus may receive a transmission power control command reported via the NUL base station in response to a physical uplink control channel (PUCCH) transmitted in the second frequency band and control the transmission power based on the command, whereby the terminal apparatus can adjust the PUCCH transmission power to an appropriate value in accordance with the communication environment. Here, the PUCCH needs to be transmitted periodically; thus, by a transmission power control command corresponding to the path loss at that time being transmitted to the terminal apparatus in a timely manner, the transmission power can appropriately follow the path loss. On the other hand, a physical uplink shared channel (PUSCH) is transmitted only at a timing when user data is transmitted, and thus may be transmitted using a transmission power that is inconsistent with the path loss at the time of transmission. Due to this, in the present embodiment, the terminal apparatus holds a cumulative value of the change in PUCCH transmission power during a period from when the random access preamble is detected by the SUL base station (i.e., from when the terminal apparatus establishes connection with the SUL base station) to when PUSCH is transmitted. Furthermore, a configuration is adopted such that the terminal apparatus determines PUSCH transmission power by identifying the cumulative value from the held information and adding the cumulative value to the transmission power when the random access preamble was detected (by the SUL base station). Here, the transmission power when the random access preamble was detected by the SUL base station is the transmission power when PUSCH is transmitted immediately following the establishment of connection, and may be equal to or different from the transmission power of the random access preamble. For example, the transmission power when the random access preamble was detected by the SUL base station is the transmission power of random-access-procedure message 3. That is, a power obtained by adding the cumulative value to the transmission power of message 3 may be used as the PUSCH transmission power. Note that the cumulative value may be simply added to the transmission power when the random access preamble was detected by the SUL base station, or a value obtained by multiplying the cumulative value by a predetermined coefficient (for example, less than 1) may be added to the transmission power. Furthermore, the terminal apparatus may hold the PUSCH transmission power, in which case, for example, the terminal apparatus may determine the transmission power of a second PUSCH by adding, to the transmission power of a first PUSCH, a cumulative value of the change in PUCCH transmission power during a period from when the first PUSCH was transmitted to when the second PUSCH, which is the PUSCH transmitted subsequent to the first PUSCH, is transmitted.

Note that the terminal apparatus may execute such a method for determining PUSCH transmission power only in the second frequency band. This is because, in the first frequency band, there is no need to use the cumulative value of the change in PUCCH transmission power since path loss can be estimated based on a downlink signal from the NUL base station, and the PUSCH transmission power can be adjusted by controlling the PUSCH transmission power so as to follow the path loss. That is, in the first frequency band, the PUSCH transmission power is determined based on a PUSCH transmission power control command without using the above-described cumulative value; on the other hand, in the second frequency band, the PUSCH transmission power is determined using the above-described cumulative value (and by further using a PUSCH transmission power control command, as necessary).

Note that, for example, upon allocating resources for user data transmission in response to the scheduling request from the terminal apparatus, the NUL base station may transmit, to the terminal apparatus, information indicating whether the first frequency band (NUL) or the second frequency band (SUL) is to be used. For example, this information may be indicated in a UL grant for allocating PUSCH resources. The UL grant is transmitted from the NUL base station to the terminal apparatus via downlink control information (DCI) format 0_0 or 0_1. For example, as illustrated in FIG. 4, once the terminal apparatus transmits, using PUCCH in the second frequency band, the scheduling request to the SUL base station with which connection has been established for example (step S401), the terminal apparatus receives, via the NUL base station and in the first frequency band, a UL grant for allocating radio resources for a buffer status report (BSR) (step S402). Then, the terminal apparatus transmits a BSR including information about the amount of transmission-target data accumulated in the buffer to the SUL base station using the allocated radio resources in the second frequency band (step S403). Then, via the NUL base station, the terminal apparatus receives a UL grant designating the PUSCH radio resources allocated based on this BSR (step S404). Note that, for example, the BSR may be transferred from the SUL base station to the NUL base station. In this case, for example, if the PUSCH transmission radio resources can be prepared using only the first frequency band, the NUL base station may determine not to use the second frequency band. Furthermore, for example, the NUL base station may receive information indicating that no radio resources can be allocated, etc., from the SUL base station, in which case the NUL base station may determine to cause the terminal apparatus to transmit the PUSCH only using the first frequency band. Furthermore, for example, when acquiring information indicating the allocation of radio resources from the SUL base station, the NUL base station may control the terminal apparatus so as to transmit PUSCH using the radio resources. In such a manner, the NUL base station can determine which of the first and second frequency bands is to be used for PUSCH transmission. Furthermore, the NUL base station may include information indicating whether the first frequency band (NUL) or the second frequency band (SUL) is to be used in the UL grant in step S404 and transmit the UL grant to the terminal apparatus. The terminal apparatus may determine the PUSCH transmission power without using the cumulative value if it is indicated by the UL grant that SUL is not to be used (step S405). On the other hand, the terminal apparatus determines the PUSCH transmission power using the cumulative value if SUL is to be used based on the UL grant. Then, the terminal apparatus transmits PUSCH using the determined transmission power (step S406). In such a manner, it becomes possible for the terminal apparatus to appropriately set the transmission power of an uplink signal to be transmitted to the SUL base station.

In the above-described procedure, the transmission power in an SUL cell is determined based on path loss in the NUL cell. This procedure is particularly effective when it can be regarded that NUL and SUL base stations are disposed at the same position. On the other hand, in a case in which the NUL base station and an SUL base station cannot be regarded as being disposed at the same position, as is the case with the relationship between the base station apparatus 101 and the base station apparatus 122 for example, an excessive or insufficient transmission power may be set. That is, the characteristics of the transmission path between the terminal apparatus and the NUL base station and the characteristics of the transmission path between the terminal apparatus and an SUL base station may significantly differ, and a situation may occur in which the transmission power set by the terminal apparatus based on the path loss of the NUL base station does not match the path loss between the SUL base station and the terminal apparatus at all.

In view of such circumstances, in the present embodiment, a configuration is adopted such that: the terminal apparatus transmits a predetermined signal (for example, an SRS or PUCCH) in the second frequency band; the predetermined signal is measured by an SUL base station; and the transmission power of an uplink signal to be transmitted to the SUL base station by the terminal apparatus is determined based on the reception quality of the measurement result. The NUL base station acquires, from an SUL base station that provides an SUL cell that can be used in combination with the NUL cell provided by the NUL base station, information indicating the reception quality, at the SUL base station, of the predetermined signal transmitted by the terminal apparatus. Note that only information indicating the reception quality at an SUL base station that is not regarded as being disposed at the same position as the NUL base station may be acquired. Then, based on the information indicating the reception quality at the SUL base station, the NUL base station generates information that allows the terminal apparatus to identify the transmission power to be used to transmit an uplink signal to the SUL base station, and transmits the information to the terminal apparatus in the first frequency band. Upon receiving the information, the terminal apparatus identifies the transmission power to be used to transmit an uplink signal to the SUL base station based on the information, and transmits an uplink signal to the SUL base station in the second frequency band using the transmission power.

Here, for example, the information reported to the terminal apparatus may include: a first received power of the predetermined signal transmitted from the terminal apparatus at a first SUL base station that is not regarded as being disposed at the same position as the NUL base station; and a second received power of the predetermined signal transmitted from the terminal apparatus at a second SUL base station that is regarded as being disposed at the same position as the NUL base station. Note that the received power of the predetermined signal may be a value obtained by subtracting, from the signal-to-noise-ratio (SNR) value of the predetermined signal at an SUL base station, the noise floor value at the SUL base station. However, there is no limitation to this, and the SNR value may be reported in place of the received power of the predetermined signal. Alternatively, the received signal strength (including noise power) of the predetermined signal at an SUL base station may be regarded as the received power of the predetermined signal. Furthermore, the information reported to the terminal apparatus may include, in place of the first received power and the second received power, a value of the difference between these received powers.

Here, the path loss between the terminal apparatus and the second SUL base station regarded as being disposed at the same position as the NUL base station can be roughly estimated based on the path loss at the NUL base station. For example, based on the path loss (PLN) at the NUL base station and the difference (FSPL2-FSPL1) between the free-space propagation loss in the first frequency band (FSPL1) and the free-space propagation loss in the second frequency band (FSPL2), the path loss (PLS2) between the terminal apparatus and the second SUL base station can be estimated as PLS2=PLN+(FSPL2−FSPL1). Here, the path loss (PLS2) between the terminal apparatus and the second SUL base station, the transmission power PT of the predetermined signal at the terminal apparatus, the received power PR2 at the second SUL base station, and the antenna gain G at the second SUL base station are in a relationship such that PT+G−PLS2=PR2 holds true. Similarly, the path loss (PLS1) between the terminal apparatus and the first SUL base station, PT, the received power PR1 at the first SUL base station, and the antenna gain G at the first SUL base station are in a relationship such that PT+G PLS1=PR1 holds true. Note that it is assumed that the first SUL base station and the second SUL base station have the same antenna gain. In this case, the difference PR1−PR2 between the first received power (PR1) and the second received power (PR2), which is reported to the terminal apparatus as described above, equals PLS2−PLS1. Thus, the terminal apparatus can calculate the path loss (PLS1) between itself and the first SUL base station, which is not regarded as being disposed at the same position as the NUL base station, as PLS1=PLS2−(PLS2−PLS1)=PLN+(FSPL2−FSPL1)−(PR1−PR2). Note that the difference in free-space propagation loss between the first and second frequency bands is a constant value regardless of distance, and the result thereof calculated in advance may be held in the terminal apparatus. Thus, the terminal apparatus can estimate the path loss between itself and the first SUL base station, which is not regarded as being disposed at the same position as the NUL base station, by acquiring the above-described first received power and second received power (or a value indicating the difference therebetween). Furthermore, based on this path loss, the terminal apparatus can identify the transmission power for transmitting an uplink signal to the first SUL base station as follows: “transmission power=desired received power at first SUL base station+path loss-antenna gain”.

Furthermore, the information reported to the terminal apparatus may be a value that is determined solely based on the reception quality (for example, the SNR) of the predetermined signal transmitted by the terminal apparatus at an SUL base station that is regarded as not being disposed at the same position as the NUL base station. For example, the NUL base station can identify the transmission power when the terminal apparatus transmitted the predetermined signal by acquiring in advance information relating to the PUSCH power headroom at the terminal apparatus. Furthermore, the NUL base station can identify the path loss between the terminal apparatus and an SUL base station as follows: “path loss of SUL base station=transmission power of terminal apparatus+antenna gain-received power of predetermined signal at SUL base station”. Note that the received power of the predetermined signal at an SUL base station may be identified as a value obtained by subtracting the noise floor value at the SUL base station from the SNR at the SUL base station when the predetermined signal was received. Furthermore, the NUL base station may report the identified path loss between the SUL base station and the terminal apparatus to the terminal apparatus. Upon receiving this path loss value, the terminal apparatus can identify the transmission power for transmitting an uplink signal to the SUL base station as follows: “transmission power=desired received power at SUL base station+path loss-antenna gain”. Note that a configuration may be adopted such that the NUL base station reports, to the terminal apparatus, information relating to the received power of the predetermined signal at an SUL base station, and the terminal apparatus identifies the path loss between the SUL base station and itself based on the above-described calculation.

Furthermore, the information reported to the terminal apparatus may include information that designates a power level to be increased or decreased by the terminal apparatus and that is identified based on the reception quality of the predetermined signal at an SUL base station and the desired reception quality at the SUL base station. For example, a value indicating the difference between the reception quality of the predetermined signal and the desired reception quality at an SUL base station is reported to the terminal apparatus. As one example, if the SNR of the predetermined signal at an SUL base station is 5 dB and the desired SNR at the SUL base station is 8 dB, information indicating that the transmission power is to be increased by 3 dB is reported to the terminal apparatus. The terminal apparatus may increase power by the reported level. Furthermore, the terminal apparatus can decrease the transmission power based on the information because, if the reception quality of the predetermined signal at an SUL base station is excessive, the value indicating the difference between the reception quality of the predetermined signal and the desired reception quality at the SUL base station would be a negative value. Note that, while an example of a case in which a value indicating the difference between the reception quality of the predetermined signal and the desired reception quality at an SUL base station is reported to the terminal apparatus has been described in the above-described example, a configuration may be adopted such that a value obtained by multiplying the value indicating the difference by a predetermined coefficient (for example, less than 1) is reported to the terminal apparatus.

Note that the reporting of information from the NUL base station to the terminal apparatus may be performed using a medium access control control element (MAC CE) in a physical downlink shared channel (PDSCH). Specifically, a new MAC CE may be defined, and information for determining the transmission power for an SUL base station that is not regarded as being disposed at the same position as the NUL base station may be reported via the MAC CE. Note that this is one example, and the information may be reported via a DCI such as the above-described UL grant in step S404, for example. Furthermore, when such information is reported, information indicating that the SUL base station to which a signal is to be transmitted is an SUL base station that is not regarded as being disposed at the same position as the NUL base station may be reported to the terminal apparatus. This information may be reported to the terminal apparatus together with the above-described information that enables identification of the transmission power, or when connection is established with the SUL base station, for example.

Due to the above, the terminal apparatus becomes capable of transmitting an uplink signal in a state in which the transmission power thereof is appropriately set not only to an SUL base station that can be regarded as being located at the same position as the NUL base station but also to an SUL base station that is disposed at a position significantly differing from that of the NUL base station. Note that the above-described information reported to the terminal apparatus may be prepared by the NUL base station or by a node other than the NUL base station. For example, the above-described information may be prepared by a network node that is capable of communicating with the NUL and SUL base stations. Alternatively, the above-described information may be prepared by a BBU accommodating the NUL and SUL base stations. However, in any case, the NUL base station provides the information to the terminal apparatus using the first frequency band.

By moving while performing uplink communication in the second frequency band as a result of connection with an SUL base station having been established, the terminal apparatus may move outside the SUL cell provided by the SUL base station. In this case, SUL cell handover needs to be executed to continue communication in the second frequency band. The switching of the connection-destination SUL cell, which is referred to herein as a handover, can be referred to in other words as the switching of a secondary cell. Conventionally, processing by the terminal apparatus for handover to a base station apparatus having excellent reception quality is initiated by the terminal apparatus measuring signals from base station apparatuses and reporting the result of the measurement to the base station apparatus that the terminal apparatus is currently connected to. However, in the present embodiment, the conventional handover processing cannot be applied because SUL base stations do not transmit signals, and the terminal apparatus cannot determine with which SUL base station excellent radio quality would be obtained.

Thus, in the present embodiment, a new procedure for SUL base station handover (cell switching) is provided.

For example, the terminal apparatus transmits a predetermined signal, and SUL base stations measure the predetermined signal. For example, the predetermined signal may be an SRS, PUCCH periodically transmitted to the SUL base station that the terminal apparatus is currently connected to, etc. Then, the SUL base stations measure the radio quality of the predetermined signal. For example, the SUL base station that the terminal apparatus is currently connected to measures the reception quality (for example, the SNR) of the predetermined signal. Furthermore, in the case of an SUL base station that the terminal apparatus is not connected to, the predetermined signal would be an interference signal; nevertheless, the SUL base station measures the reception quality (for example, the interference-to-noise ratio (INR)) of the interference signal. Note that the radio resources that the terminal apparatus uses to transmit the predetermined signal may be those uniquely allocated to individual terminal apparatuses so that it can be identified from which terminal apparatus the signal has been transmitted. Furthermore, if the predetermined signal is an SRS, for example, a configuration may be adopted such that reference signals of different sequences are transmitted by individual terminal apparatuses. Furthermore, the radio resources (and sequence) that the terminal apparatus uses to transmit the predetermined signal are allocated so as to be the same among one or more SUL cells overlapping the NUL cell. Note that the allocation of the radio resources (and sequence) is reported to the terminal apparatus from the NUL base station using the first frequency band. Thus, it can be ensured that, if a plurality of SUL cells overlap the NUL cell, the measurement of the predetermined signal transmitted by the terminal apparatus is performed in parallel in the SUL cells.

The SNR/INR measured by the SUL base stations are provided to the NUL base station for example, and, based on the acquired SNR/INR, the NUL base station determines whether or not to cause the terminal apparatus to switch the connection-destination cell. That is, conventionally, processing for switching the connection-destination cell is performed by a terminal apparatus measuring the received qualities of signals from base station apparatuses and providing a report of the result of the measurement to the connection-destination base station apparatus based on the received qualities; however, in the present embodiment, a configuration is adopted such that processing for switching the connection-destination cell is performed based on the result of measurement by base station apparatuses of a signal transmitted by the terminal apparatus.

For example, based on the reception quality (INR) of the predetermined signal (interference signal) transmitted by the terminal apparatus exceeding a predetermined value at an SUL base station that the terminal apparatus is not connected to, the NUL base station may determine to switch the connection-destination base station apparatus of the terminal apparatus in the second frequency band to the SUL base station. Alternatively, for example, the NUL base station may determine to switch the connection-destination base station apparatus of the terminal apparatus in the second frequency band from a second SUL base station that the terminal apparatus is connected to a first SUL base station that the terminal apparatus is not connected to based on the reception quality (INR) of the predetermined signal (interference signal) transmitted by the terminal apparatus at the first SUL base station becoming higher than the reception quality (SNR) of the predetermined signal transmitted by the terminal apparatus at the second SUL base station by a predetermined level or more.

Upon determining that the terminal apparatus is to switch the connection-destination SUL base station, the NUL base station may report, to the terminal apparatus using the first frequency band, an instruction to switch the connection-destination SUL base station with a designation of the SUL base station after the switch. Upon receiving the instruction, the terminal apparatus switches the connection destination in the second frequency band to the designated SUL base station based on the instruction.

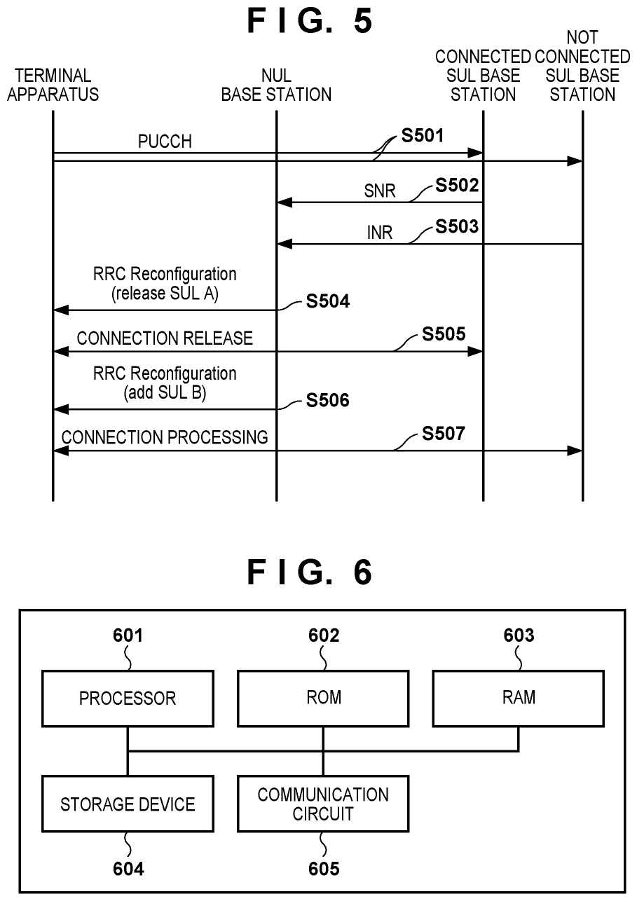

FIG. 5 illustrates an example of a flow of processing for switching the connection-destination SUL base station. First, the predetermined signal (PUCCH in the example in FIG. 5) transmitted by the terminal apparatus is measured by SUL base stations respectively providing SUL cells that can be used in combination with the NUL cell that the terminal apparatus is currently connected to (step S501). Here, the SUL base station that the terminal apparatus is currently connected to measures the SNR based on the predetermined signal, and an SUL base station that the terminal apparatus is not connected to measures the INR based on the predetermined signal. Then, the SUL base stations report the measured SNR/INR to the NUL base station (steps S502 and S503). Note that the SNR and INR are examples of received qualities, and, for example, received signal power, received interference power, SINR, the ratio of the interference power based on the predetermined signal to the power of other interferences and noise, or the like may be reported to the NUL base station. Based on the reports, the NUL base station may determine to switch the connection-destination SUL base station of the terminal apparatus if the INR has exceeded a predetermined value, the INR has become higher than the SNR by a predetermined level or more, or the like, for example. Then, for example, the NUL base station transmits, to the terminal apparatus, an instruction to release the connection with the SUL base station that the terminal apparatus is currently connected to (step S504), and an instruction to establish connection with the connection-destination SUL base station after the switch (step S506). Note that the instructions in steps S504 and S506 may be transmitted via two separate messages as in FIG. 5, or may be transmitted at once via one message. Upon receiving the instructions, the terminal apparatus executes processing for releasing the connection with the SUL base station that the terminal apparatus is currently connected to (step S505), and executes processing for establishing a connection with the connection-destination SUL base station after the switch (step S507).

As a result of the above-described processing, it becomes possible to continue communication while appropriately switching the SUL base station that the terminal apparatus is to be connected to in an environment in which SUL base stations not transmitting downlink signals are provided.

FIG. 6 illustrates an example of a hardware configuration of the terminal apparatus and base station apparatuses according to the present embodiment. In one example, the terminal apparatus and base station apparatuses are configured to include a processor 601, a ROM 602, a RAM 603, a storage device 604, and a communication circuit 605. The processor 601 is a computer configured to include one or more processing circuits such as general-purpose central processing units (CPUs) or application specific integrated circuits (ASICs), and executes processing relating to the entire apparatus and each process described above by reading out and executing one or more programs stored in the ROM 602 and the storage device 604. The ROM 602 is a read-only memory that stores therein information such as programs and various parameters relating to processing executed by the terminal apparatus and the base station apparatuses. The RAM 603 functions as a work space when the processor 601 executes programs, and is a random access memory that stores temporary information. The storage device 604 is formed by a removable external storage device or the like. The communication circuit 605 is formed by a circuit for radio communication based on 5G and standards subsequent thereto, for example. Note that, while one communication circuit 605 is illustrated in FIG. 6, the terminal apparatus and base station apparatuses may each include a plurality of communication circuits. For example, the terminal apparatus and base station apparatuses may each include radio communication circuits respectively for 5G and a standard subsequent thereto, and an antenna shared by the circuits. Note that the terminal apparatus and base station apparatuses may include separate antennas suitable for the respective standards. In addition, the base station apparatuses may each further include a wired communication circuit that is used to communicate with other base station apparatuses and core network nodes. Furthermore, the terminal apparatus may further include communication circuits, etc., that conform to radio communication standards other than cellular communication standards, such as wireless local area network (LAN) and Bluetooth (registered trademark). Note that the terminal apparatus and base station apparatuses may include separate communication circuits 605 respectively for a plurality of available frequency bands, or may include a communication circuit 605 that is shared by at least some of the frequency bands.

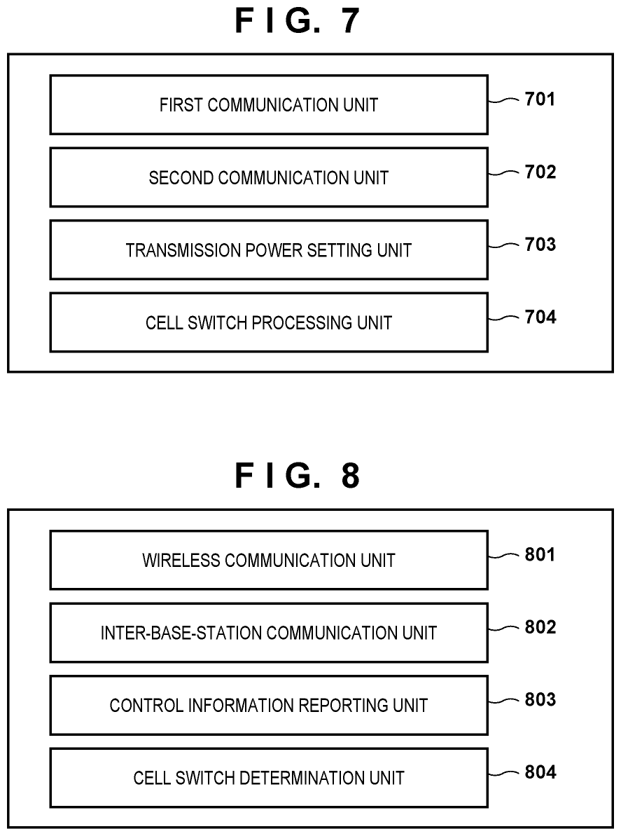

FIG. 7 illustrates an example of a functional configuration of the terminal apparatus according to the present embodiment. For example, the terminal apparatus includes, as functions thereof, a first communication unit 701, a second communication unit 702, a transmission power setting unit 703, and a cell switch processing unit 704. Note that only functions particularly relating to the present embodiment are illustrated in FIG. 7, and other various functions that the terminal apparatus may include are omitted from the drawing. For example, the terminal apparatus includes, as a matter of course, other functions that a terminal apparatus conforming to 5G, a standard subsequent thereto, etc., would typically include. Furthermore, the functional blocks in FIG. 7 are illustrated schematically, and the functional blocks may be implemented in an integrated state or may be further divided. Furthermore, the functions in FIG. 7 may each be implemented, for example, by the processor 601 executing one or more programs stored in the ROM 602 and the storage device 604, or may be implemented by a processor present in the communication circuit 605 executing one or more predetermined pieces of software. Note that, because the details of the processing executed by each functional unit are as already described above, description thereof will not be repeated here, and only an overview of the general functions thereof is provided.

The first communication unit 701 uses the first frequency band to establish connection with the NUL base station and communicate with the NUL base station. The first communication unit 701 receives downlink signals from the NUL base station, and transmits uplink signals to the NUL base station. The second communication unit 702 uses the second frequency band to establish connection with SUL base stations and communicate with SUL base stations. Note that, because communication by the second communication unit 702 is controlled based on control information received from the NUL base station using the first communication unit 701, communication by the second communication unit 702 is executed on the condition that connection with the NUL base station has been established using the first communication unit 701. The second communication unit 702 transmits uplink signals to SUL base stations, but does not receive downlink signals. The transmission power setting unit 703 controls the transmission power of uplink signals (for example, the random access preamble, PUCCH, PUSCH, etc.) transmitted by the second communication unit 702. Because the specific details of the transmission power control are as already described above, description will not be repeated here. Note that, while the transmission power of uplink signals transmitted by the first communication unit 701 is also set based on instructions from the NUL base station, this processing is similar to conventional transmission power control and thus will not be described here. If an instruction for switching the connection-destination SUL base station is received from the NUL base station by the first communication unit 701, the cell switch processing unit 704 switches the connection-destination SUL base station in accordance with the instruction. This processing is also as already described above, and thus description will not be repeated here.

FIG. 8 illustrates an example of a functional configuration of a base station apparatus (NUL base station) according to the present embodiment. For example, the NUL base station includes, as functions thereof, a wireless communication unit 801, an inter-base-station communication unit 802, a control information reporting unit 803, and a cell switch determination unit 804. Note that only functions particularly relating to the present embodiment are illustrated in FIG. 8, and other various functions that the NUL base station may include are omitted from the drawing. For example, the NUL base station includes, as a matter of course, other functions that a terminal apparatus conforming to 5G, a standard subsequent thereto, etc., would typically include. Furthermore, the functional blocks in FIG. 8 are illustrated schematically, and the functional blocks may be implemented in an integrated state or may be further divided. Furthermore, the functions in FIG. 8 may each be implemented, for example, by the processor 601 executing one or more programs stored in the ROM 602 and the storage device 604, or may be implemented by a processor present in the communication circuit 605 executing one or more predetermined pieces of software. Note that, because the details of the processing executed by each functional unit are as already described above, description thereof will not be repeated here, and only an overview of the general functions thereof is provided.

The wireless communication unit 801 uses the first frequency band to establish radio connection with the terminal apparatus and communicate with the terminal apparatus. The wireless communication unit 801 receives uplink signals from the terminal apparatus, with which connection has been established, and transmits downlink signals to the terminal apparatus. The inter-base-station communication unit 802 transmits and receives information that is necessary to control communication by the terminal apparatus to and from one or more SUL base stations that provide SUL cells overlapping the NUL cell provided by the wireless communication unit 801, for example. For example, the inter-base-station communication unit 802 may receive, from an SUL base station, downlink control information that needs to be transmitted to the terminal apparatus for communication with the SUL base station. Furthermore, for example, if the NUL base station determines the configuration of radio resources, etc., via which the terminal apparatus transmits a predetermined signal so as to be the same for a plurality of SUL cells, the inter-base-station communication unit 802 may report information indicating the configuration to SUL base stations. Furthermore, the inter-base-station communication unit 802 acquires, from an SUL base station, information indicating the reception quality, at the SUL base station, of a signal from the terminal apparatus. Other pieces of information that need to be exchanged between the NUL and SUL base stations are transmitted and received via the inter-base-station communication unit 802. The control information reporting unit 803 reports, to the terminal apparatus, control information for communication with an SUL base station. For example, the control information may be various types of information such as the amount of increase in transmission power when the random access preamble is retransmitted, information as to whether or not SUL is to be used, and switching of the connection-destination SUL base station. The details have been described above, and thus will not be repeated here. Based on at least the reception quality of a signal (interference signal) transmitted from the terminal apparatus at an SUL base station that the terminal apparatus is not connected to, the cell switch determination unit 804 determines whether or not the SUL base station that the terminal apparatus is currently connected to is to be switched. Furthermore, upon determining that the connection-destination SUL base station is to be switched, the cell switch determination unit 804 transmits, to the terminal apparatus via the control information reporting unit 803, an instruction to switch the connection-destination SUL base station.

The processing and configurations as described above make it possible to appropriately control communication by a terminal apparatus in an environment in which a second frequency band in which only uplink signals can be transmitted is used in a supplementary manner in uplink communication. Accordingly, it becomes possible to contribute to Goal 9 of the Sustainable Development Goals (SDGs) led by the United Nations: “Build resilient infrastructure, promote inclusive and sustainable industrialization and foster innovation.”

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A terminal apparatus comprising:
one or more processors; and
one or more memories that store a computer-readable instruction for causing, when executed by the one or more processors, the one or more processors to execute a control method including:
establishing a connection with a first base station apparatus in a first frequency band, and establishing a connection with a base station apparatus that is different from the first base station apparatus in a second frequency band that is different from the first frequency band;
transmitting a predetermined signal in the second frequency band;
receiving, from the first base station apparatus, information that is based on a reception quality of the predetermined signal at a second base station apparatus and that enables identifying a transmission power to be used to transmit a signal to the second base station apparatus, the second base station apparatus operating in the second frequency band and not being regarded as being located at the same position as the first base station apparatus; and
identifying the transmission power based on the information, and transmitting a signal to the second base station apparatus in the second frequency band using the transmission power.

2. The terminal apparatus according to claim 1,
wherein the information includes a first reception quality of the predetermined signal at the second base station apparatus and a second reception quality of the predetermined signal at a third base station apparatus that operates in the second frequency band and that is regarded as being located at the same position as the first base station apparatus, and
based on the first reception quality, the second reception quality, and a first path loss between the terminal apparatus and the first base station apparatus, the terminal apparatus identifies a second path loss between the terminal apparatus and the second base station apparatus, and identifies the transmission power based on the second path loss.

3. The terminal apparatus according to claim 1,
wherein the information includes information indicating a path loss between the terminal apparatus and the second base station apparatus, the path loss being identified based on the reception quality of the predetermined signal at the second base station apparatus and a power headroom at the terminal apparatus, and
the terminal apparatus identifies the transmission power based on the path loss.

4. The terminal apparatus according to claim 1,
wherein the information includes information designating a power level by which a power is to be increased or decreased by the terminal apparatus, the power level being identified based on the reception quality of the predetermined signal at the second base station apparatus and a desired reception quality at the second base station apparatus, and
the terminal apparatus identifies the transmission power by increasing or decreasing a power used to transmit a signal to the second base station apparatus, by the power level designated by the information.

5. The terminal apparatus according to claim 1,
wherein the predetermined signal is a sounding reference signal (SRS) or a physical uplink control channel (PUCCH).

6. The terminal apparatus according to claim 1,
wherein the first frequency band is a frequency band in which both uplink signals and downlink signals are transmitted, and the second frequency band is a frequency band in which only uplink signals are transmitted.

7. The terminal apparatus according to claim 1,
wherein the terminal apparatus establishes connection with a base station apparatus that operates in the second frequency band, by processing including: transmitting, via a same resource, a random access preamble to a plurality of base station apparatuses operating in the second frequency band; and receiving, from the first base station apparatus in the first frequency band, a random access response for connection with a base station apparatus selected based on radio qualities when the random access preamble is received by the plurality of base station apparatuses.

8. The terminal apparatus according to claim 1,
wherein the terminal apparatus receives the information via a medium access control control element (MAC CE) in a physical downlink shared channel (PDSCH).

9. A base station apparatus that operates in a first frequency band, comprising:
one or more processors; and
one or more memories that store a computer-readable instruction for causing, when executed by the one or more processors, the one or more processors to execute a control method including:
acquiring information about a reception quality when a predetermined signal transmitted from a terminal apparatus in a second frequency band that is different from the first frequency band is received by a first other base station apparatus that operates in the second frequency band and that is not regarded as being located at a same position as the base station apparatus; and
based on the reception quality, generating information that enables identifying a transmission power to be used by the terminal apparatus to transmit a signal to the first other base station apparatus, and transmitting the information to the terminal apparatus in the first frequency band.

10. The base station apparatus according to claim 9,
wherein the base station apparatus acquires a first reception quality of the predetermined signal at the first other base station apparatus and a second reception quality of the predetermined signal at a second other base station apparatus that operates in the second frequency band and that is regarded as being located at the same position as the base station apparatus,
the base station apparatus generates the information including the first reception quality and the second reception quality and transmits the information to the terminal apparatus, and
the transmission power is identified based on a second path loss between the terminal apparatus and the first other base station apparatus, the second path loss being identified using the first reception quality, the second reception quality, and a first path loss between the terminal apparatus and the base station apparatus.

11. The base station apparatus according to claim 9,
wherein the control method further includes identifying a path loss between the terminal apparatus and the first other base station apparatus based on the reception quality of the predetermined signal at the first other base station apparatus and a power headroom at the terminal apparatus, and
the base station apparatus generates the information including the identified path loss and transmits the information to the terminal apparatus.

12. The base station apparatus according to claim 9,
wherein the control method further includes identifying a power level by which a power is to be increased or decreased by the terminal apparatus, the power level being identified based on the reception quality of the predetermined signal at the first other base station apparatus and a desired reception quality at the first other base station apparatus, and
the base station apparatus generates the information including a value indicating the power level by which a power is to be increased or decreased by the terminal apparatus and transmits the information to the terminal apparatus.

13. The base station apparatus according to claim 9,
wherein the first frequency band is a frequency band in which both uplink signals and downlink signals are transmitted, and the second frequency band is a frequency band in which only uplink signals are transmitted.

14. The base station apparatus according to claim 9,
wherein the information is transmitted to the terminal apparatus via a medium access control control element (MAC CE) in a physical downlink shared channel (PDSCH).

15. A control method executed by a terminal apparatus, comprising:
establishing a connection with a first base station apparatus in a first frequency band, and establishing a connection with a base station apparatus that is different from the first base station apparatus in a second frequency band that is different from the first frequency band;
transmitting a predetermined signal in the second frequency band;
receiving, from the first base station apparatus, information that is based on a reception quality of the predetermined signal at a second base station apparatus and that enables identifying a transmission power to be used to transmit a signal to the second base station apparatus, the second base station apparatus operating in the second frequency band and not being regarded as being located at the same position as the first base station apparatus; and
identifying the transmission power based on the information, and transmitting a signal to the second base station apparatus in the second frequency band using the transmission power.

16. A control method executed by a base station apparatus that operates in a first frequency band, comprising:
acquiring information about a reception quality when a predetermined signal transmitted from a terminal apparatus in a second frequency band that is different from the first frequency band is received by a first other base station apparatus that operates in the second frequency band and that is not regarded as being located at a same position as the base station apparatus; and
based on the reception quality, generating information that enables identifying a transmission power to be used by the terminal apparatus to transmit a signal to the first other base station apparatus, and transmitting the information to the terminal apparatus in the first frequency band.

17. A non-transitory computer-readable storage medium that stores a program for causing a computer included in a terminal apparatus to execute a control method including:
establishing a connection with a first base station apparatus in a first frequency band, and establishing a connection with a base station apparatus that is different from the first base station apparatus in a second frequency band that is different from the first frequency band;
transmitting a predetermined signal in the second frequency band;
receiving, from the first base station apparatus, information that is based on a reception quality of the predetermined signal at a second base station apparatus and that enables identifying a transmission power to be used to transmit a signal to the second base station apparatus, the second base station apparatus operating in the second frequency band and not being regarded as being located at the same position as the first base station apparatus; and
identifying the transmission power based on the information, and transmitting a signal to the second base station apparatus in the second frequency band using the transmission power.

18. A non-transitory computer-readable storage medium that stores a program for causing a computer included in a base station apparatus that operates in a first frequency band to execute a control method including:
acquiring information about a reception quality when a predetermined signal transmitted from a terminal apparatus in a second frequency band that is different from the first frequency band is received by a first other base station apparatus that operates in the second frequency band and that is not regarded as being located at a same position as the base station apparatus; and
based on the reception quality, generating information that enables identifying a transmission power to be used by the terminal apparatus to transmit a signal to the first other base station apparatus, and transmitting the information to the terminal apparatus in the first frequency band.
